(19) United States
(12) Patent Application Publication
(10) Pub. No.: US 2016/0153901 A1
(43) Pub. Date: Jun. 2, 2016

(54) METHOD FOR MEASURING REFRACTIVE INDEX, REFRACTIVE INDEX MEASURING DEVICE, AND METHOD FOR PRODUCING OPTICAL ELEMENT

(71) Applicant: CANON KABUSHIKI KAISHA, Ohta-ku, Tokyo (JP)

(72) Inventor: Tomohiro Sugimoto, Yoshikawa-shi (JP)

(21) Appl. No.: 14/900,595

(22) PCT Filed: Jun. 18, 2014
(86) PCT No.: PCT/JP2014/066754

§ 371 Date: Dec. 21, 2015

(30) Foreign Application Priority Data
Jun. 28, 2013 (JP) 2013-136168

(51) Int. Cl. G01N 21/45; G01M 11/02

(52) U.S. Cl. CPC G01N 21/45; G01M 11/0228; G01N 2201/13

(57) ABSTRACT

The refractive index of a test object is measured with high precision.

The present invention relates to a method for measuring a refractive index of a test object by splitting light from a light source into test light and reference light and measuring interference light resulting from interference between the reference light and the test light transmitted through the test object. In the method, the test object is arranged in a medium whose group refractive index is equal to a group refractive index of the test object at a particular wavelength, interference light is measured, the particular wavelength is determined based on a wavelength dependence of a phase difference between the test light and the reference light, and the group refractive index of the medium corresponding to the particular wavelength is calculated as the group refractive index of the test object corresponding to the particular wavelength.

### TECHNICAL FIELD

The present invention relates to a method for measuring a refractive index and a refractive index measuring device. More particularly, the present invention is useful for measuring the refractive index of an optical element that is produced by molding.

### BACKGROUND ART

The refractive index of a mold lens changes according to a mold condition. In general, the refractive index of a mold lens is measured by a minimum deviation angle method or a V block method after processing the lens into the form of a prism. This processing operation is troublesome and costly to perform. Further, the refractive index of the lens after the molding changes due to stress release during the processing operation. Therefore, a technology for nondestructively measuring the refractive index of a mold lens is required.

PTL 1 discusses a method in which a test object whose phase refractive index and shape are unknown and a glass sample whose phase refractive index and shape are known are immersed in two types of phase refractive index matching liquids, interference fringes are measured using coherent light, the phase refractive index of oil is measured from the interference fringes of the glass sample, and the phase refractive index of the test object is calculated using the phase refractive index of the oil. In NPL 1, the following method is described. That is, in the method, an interference signal resulting from interference between reference light and test light is measured as a function of wavelength, a particular wavelength whose phase differences are extreme values is calculated, and the refractive index is calculated using a model fitting to the interference signal.

In the method disclosed in PTL 1, since the transmittance of matching oil having a high phase refractive index is low, only a small signal is obtained in measuring a transmitted wavefront of the test object having a high phase refractive index. Therefore, the measurement precision is reduced.

In the method disclosed in NPL 1, an offset term (term that is an integral multiple of 2π) of the phase of the interference signal is unknown. Therefore, the fitting precision is reduced. Further, it is necessary to know the thickness of the test object.

### CITATION LIST

### Patent Literature

PTL 1 U.S. Pat. No. 5,151,752

### Non Patent Literature

NPL 1 High-precision index measurement in anisotropic crystals using white-light spectral interferometry (applied physics B, 2000, vol. 70, pp. 45-51) by H. Delbarre, C. Przygodski, M. Tassou, and D. Boucher

### SUMMARY OF INVENTION

### Solution to Problem

The present invention provides a method for measuring a refractive index of a test object by splitting light from a light source into test light and reference light, introducing the test light into the test object, and measuring interference light resulting from interference between the reference light and the test light transmitted through the test object. The method includes steps of measuring, by arranging the test object in a medium whose group refractive index is equal to a group refractive index of the test object at a particular wavelength, interference light resulting from interference between test light transmitted through the test object and the medium and reference light transmitted through the medium; determining the particular wavelength based on a wavelength dependence of a phase difference between the test light and the reference light; and calculating the group refractive index of the medium corresponding to the particular wavelength as the group refractive index of the test object corresponding to the particular wavelength.

The present invention also provides a method for producing an optical element. The method includes steps of molding the optical element, and evaluating the molded optical element by measuring a refractive index of the optical element using the above-described method for measuring a refractive index.

The present invention further provides a refractive index measuring device including a light source; an interference optical system configured to split light from the light source into test light and reference light, introduce the test light into a test object, and cause the reference light and the test light transmitted through the test object to interfere with each other; a detecting unit configured to detect interference light resulting from the interference between the test light and the reference light; and a computing unit configured to compute a refractive index of the test object using an interference signal that is output from the detecting unit. The test object is arranged in a medium whose group refractive index is equal to a group refractive index of the test object at a particular wavelength. The interference optical system is an optical system that causes test light transmitted through the test object and the medium and reference light transmitted through the medium to interfere with each other. The computing unit determines the particular wavelength based on a wavelength dependence of a phase difference between the test light and the reference light and calculates the group refractive index of the medium corresponding to the particular wavelength as the group refractive index of the test object corresponding to the particular wavelength.

Further features of the present invention will become apparent from the following description of exemplary embodiments with reference to the attached drawings.

### BRIEF DESCRIPTION OF DRAWINGS

FIG. 1 is a block diagram of a refractive index measuring device according to a first embodiment of the present invention.

FIG. 2 is a flowchart of a procedure for calculating a group refractive index of a test object using the refractive index measuring device according to the first embodiment of the present invention.

FIG. 3A is a graph showing the relationship between phase refractive index and wavelength of a test object and a medium.

FIG. 3B is a graph showing the relationship between group refractive index and wavelength of the test object and the medium.

FIGS. 4A and 4B are graphs each showing an interference signal that is obtained with a detector of the refractive index measuring device according to the first embodiment of the present invention.

FIG. 5 is a block diagram of a refractive index measuring device according to a second embodiment of the present invention.

FIG. 6 is a block diagram of a refractive index measuring device according to a third embodiment of the present invention.

FIG. 7 illustrates the production steps of a method for producing an optical element according to a fourth embodiment of the present invention.

### DESCRIPTION OF EMBODIMENTS

Embodiments of the present invention are hereunder described with reference to the attached drawings.

### First Embodiment

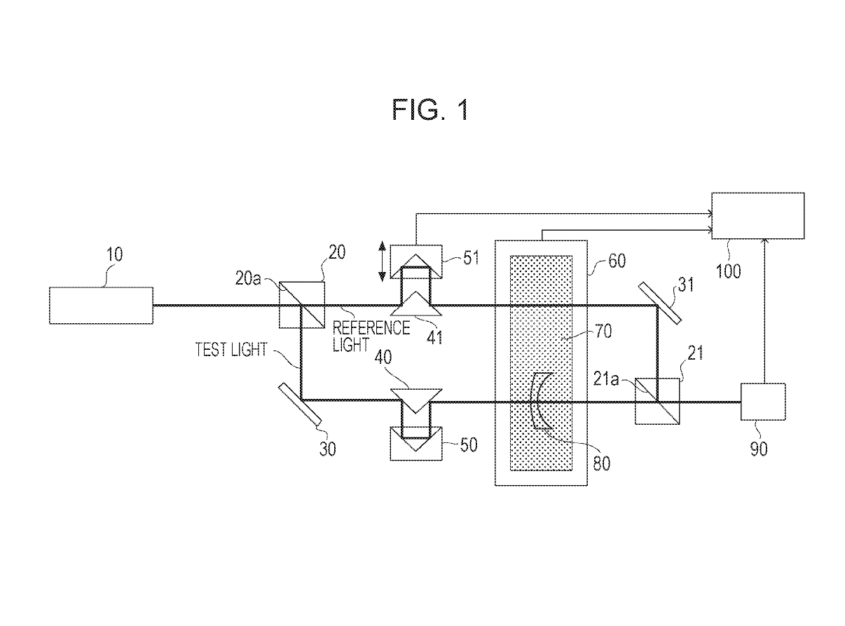

FIG. 1 is a block diagram of a refractive index measuring device according to a first embodiment of the present invention. The refractive index measuring device according to the first embodiment includes a Mach-Zehnder interferometer. In the first embodiment, by placing a test object in a medium (such as oil) having a group refractive index equal to the group refractive index of the test object at a particular wavelength, the thickness of the test object is removed to measure the group refractive index of the test object.

Refractive indices include a phase refractive index Nₚ(λ) related to a phase speed vₚ(λ), which is the speed of movement of an equiphase surface of light, and a group refractive index N_{g}(λ) related to a movement speed V_{g}(λ) of light energy (movement speed of a wavepacket). It is possible to convert these refractive indices into each other using Formula 6 described below.

In the embodiment, the test object is a lens having a negative refractive power (reciprocal of the focal length) Since the refractive index measuring device measures the refractive index of the test object, the test object may be a lens or a flat plate, and only needs to be a refractive optical element.

The refractive index measuring device includes a light source 10, an interference optical system, a container 60 that is capable of containing a medium 70 and a test object 80, a detector 90, and a computer (computing unit) 100. The refractive index measuring device measures the refractive index of the test object 80.

The light source 10 is a light source having a wide wavelength band (such as a supercontinuum light source). The interference optical system splits light from the light source 10 into light that is not transmitted through the test object (reference light) and light that is transmitted through the test object (test light), causes the reference light and the test light to be superposed upon each other and interfere with each other, and guides the interference light to the detector 90. The interference optical system includes beam splitters 20 and 21, and mirrors 30, 31, 40, 41, 50, and 51.

The beam splitters 20 and 21 are, for example, cube beam splitters. An interface (joined surface) 20a of the beam splitter 20 transmits part of the light from the light source 10 and, at the same time, reflects the remaining part of the light from the light source 10. The part of the light transmitted through the interface 20a becomes the reference light, and the part of the light that is reflected by the interface 20a becomes the test light. An interface 21a of the beam splitter 21a reflects part of the reference light, and transmits part of the test light. As a result, the reference light and the test light interfere with each other, so that interference light is formed. The interference light exits towards the detector 90.

The container 60 contains the medium 70 and the test object 80. It is desirable that an optical path length of the reference light and an optical path length of the test light in the container be the same when the test object is not arranged in the container. Therefore, it is desirable that the thicknesses and the refractive indices of the side surfaces of the container 60 (such as glass) be uniform, and that both side surfaces of the container 60 be parallel to each other. The container 60 includes a temperature regulating mechanism (temperature regulating unit), and is capable of, for example, controlling a change in the temperature of the medium and the temperature distribution of the medium.

The refractive index of the medium 70 is calculated using a medium refractive index calculating unit (not shown). The medium refractive index calculating unit includes, for example, a temperature measuring unit that measures the temperature of the medium and a computer that converts the measured temperature into the refractive index of the medium. More specifically, the medium refractive index calculating unit only needs to include a computer provided with a memory that stores refractive indices at different wavelengths at a particular temperature and temperature coefficients of the refractive indices at the different wavelengths. This makes it possible for the computer to calculate, using the temperature of the medium 70 measured by the temperature measuring unit, the refractive index of the medium 70 at each wavelength at the measured temperature. When the change in temperature of the medium 70 is small, a lookup table indicating refractive index data at each wavelength at a particular temperature may be used. The medium refractive index calculating unit includes a glass prism (reference test object) whose refractive index and shape are known, a wavefront measuring sensor (wavefront measuring unit) that measures a transmitted wavefront of the glass prism arranged in the medium, and a computer that calculates the refractive index of the medium from the transmitted wavefront and the refractive index and shape of the glass prism. The medium refractive index calculating unit may measure phase refractive index or group refractive index.

The mirrors 40 and 41 are, for example, prismatic mirrors. The mirrors 50 and 51 are, for example, corner cube reflectors. The mirror 51 is provided with a driving mechanism for driving operations in the directions of a double-headed arrow in FIG. 1. For example, the driving mechanism of the mirror 51 includes a stage having a large driving range and a piezoelectric element having a high driving resolving power. The driving amount of the mirror 51 is measured by a length measuring unit (not shown), such as a laser length measuring unit or an encoder. The driving of the mirror 51 is controlled by the computer 100. The difference between the optical path length of the reference light and the optical path length of the test light can be adjusted by the driving mechanism of the mirror 51.

The detector 90 includes, for example, a spectrometer that spectrally disperses the interference light from the beam splitter 21, and detects the intensity of the interference light as a function of wavelength (frequency).

The computer 100 functions as a computing unit that computes the refractive index of the test object 80 using the interference signal that is output from the detector 90, and a controlling unit that controls the driving amount of the mirror 51. The computer 100 includes, for example, a central processing unit (CPU). However, the computing unit that calculates the refractive index of the test object from the interference signal that is output from the detector 90 and the controlling unit that controls the driving amount of the mirror 51 and the temperature of the medium 70 may be formed from different computers.

The interference optical system is adjusted so that the optical path length of the reference light and the optical path length of the test light are equal to each other while the test object 80 is not arranged in the container. The adjustment method is as follows.

In the refractive index measuring device shown in FIG. 1, the interference signal resulting from interference between the reference light and the test light is obtained while the test object 80 is not arranged in the optical light paths. Here, a phase difference φ₀(λ) between the reference light and the test light and an interference intensity I₀(λ) of the reference light and the test light are expressed by the following Formula 1:

$$\begin{matrix}{φ}_{0} ( λ ) = \frac{2 π}{λ} ( - {Δ}_{0} ) & [ Math . 1 ] \\ {I}_{0} ( λ ) = {I}_{0} ( 1 + γ cos {φ}_{0} ( λ ) ) & \end{matrix}$$

where λ is the wavelength in air, Δ₀ is the difference between the optical path length of the reference light and the optical path length of the test light, I₀ is the sum of the intensity of the reference light and the intensity of the test light, and γ is the visibility. From Formula 1, when Δ₀ is not zero, the interference intensity I₀(λ) is a vibrational function. Therefore, in order for the optical path length of the reference light and the optical path length of the test light to be equal to each other, the mirror 51 is driven to a position where the interference signal does not become a vibrational function. Here, Δ₀ is zero.

Here, although the case in which the interference optical system is adjusted so that the optical path length of the test light and the optical path length of the reference light become equal to each other (Δ₀=0) is described, if the amount of shift of a current position of the mirror 51 from Δ₀=0 is known, the optical path length of the test light and the optical path length of the reference light need not be made equal to each other. The driving amount of the mirror 51 from the position where the optical path length of the test light and the optical path length of the reference light become equal to each other (Δ₀=0) can be measured using a length measuring unit (not shown), such as a laser length measuring unit or an encoder.

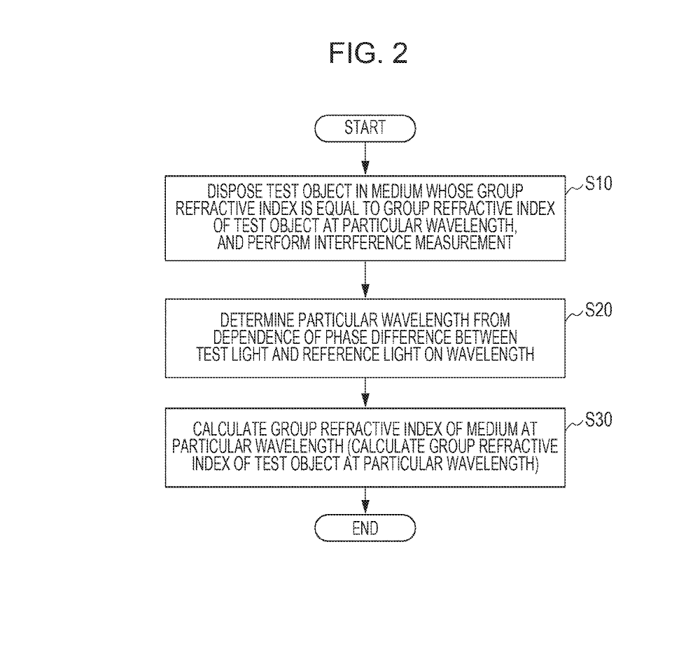

FIG. 2 is a flowchart of a procedure for calculating a group refractive index of the test object 80. “S” is an abbreviation for step.

First, the test object 80 and the medium 70 having a group refractive index that is equal to the group refractive index of the test object at a particular wavelength are arranged in the container 60. At this time, the medium 70 and the test object 80 are arranged so that test light is transmitted through the test object 80 and the medium 70 and reference light is transmitted through the medium 70. Then, interference light resulting from interference between the test light and the reference light are measured using the detector 90 (S10).

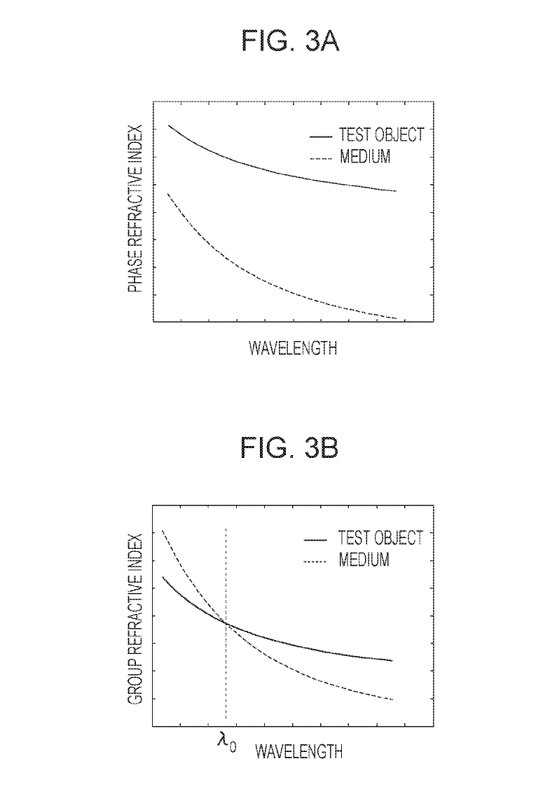

In general, since an ultraviolet absorption band of oil is closer to visible light than an ultraviolet absorption band of glass material, the tilting of a refractive index dispersion curve of a visible light region is steeper for the oil than the glass material. FIG. 3A is a graph of a phase refractive index dispersion curve of the test object and that of the medium. FIG. 3B is a graph of a group refractive index dispersion curve of the test object and that of the medium. The group refractive index of the test object and that of the medium become equal to each other at a point of intersection in FIG. 3B. A wavelength λ₀ at the point of intersection in FIG. 3B corresponds to a particular wavelength. Even in a region of a high refractive index where an effective phase refractive index matching oil does not exist, oil that allows group refractive index matching exists. The medium also has the role of reducing the effect of refraction at a surface of the test object.

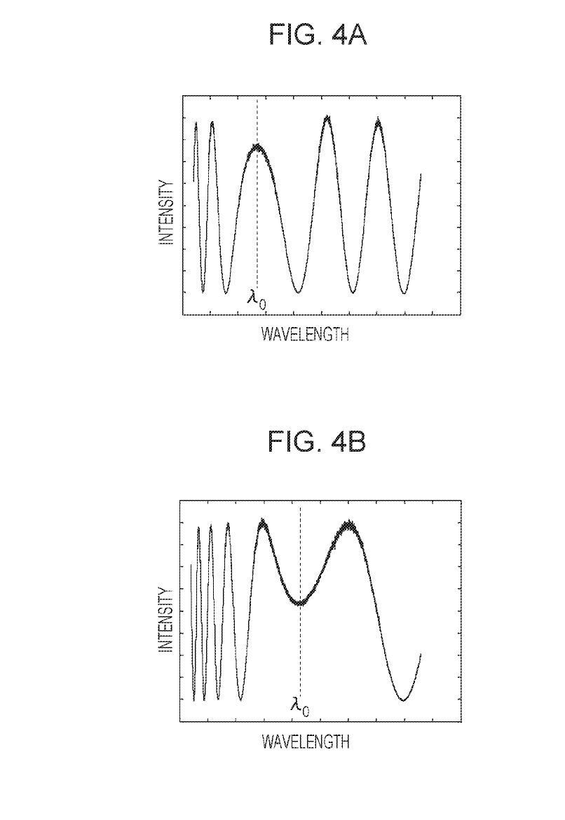

Next, using the interference signal that is output from the detector 90, the particular wavelength λ₀ is determined from the wavelength dependence of the phase difference between the reference light and the test light (S20). The interference signal in a spectral region that is output from the detector 90 in FIG. 1 is illustrated in FIGS. 4A and 4B. FIGS. 4A and 4B are graphs showing interference signals that are measured at different temperatures of the medium 70. The phase difference φ(λ) between the reference light and the test light and the interference intensity I(λ) of the reference light and the test light are expressed by the following Formula 2:

$$\begin{matrix}φ ( λ ) = \frac{2 π}{λ} ( {n}^{sample} ( λ ) - {n}^{medium} ( λ ) ) L & [ Math . 2 ] \\ I ( λ ) = {I}_{0} ( 1 + γ cos φ ( λ ) ) & \end{matrix}$$

where n^{sample}(λ) is the phase refractive index of the test object, n^{medium}(λ) is the phase refractive index of the medium, and L is the geometric thickness of the test object. As can be understood from FIGS. 4A and 4B and Formula 2, the interference signals are vibrational functions that reflect the wavelength dependence of the phase difference φ(λ).

λ₀ in each of FIGS. 4A and 4B represents a wavelength at which the phase difference φ(λ) is an extreme value. The tilting of the phase difference φ(λ) regarding the wavelength, that is, a phase-difference differential dφ(λ)/dλ is expressed by Formula 3:

$$\frac{d φ ( λ )}{d λ} = - \frac{2 π}{{λ}^{2}} ( {n}_{g}^{sample} ( λ ) - {n}_{g}^{medium} ( λ ) ) L \qquad [ Math . 3 ]$$

where n_{g}^{sample}(λ) is the group refractive index of the test object, and n_{g}^{medium}(λ) is the group refractive index of the medium. The wavelength λ₀ in each of FIGS. 4A and 4B at which the phase difference φ(λ) becomes an extreme value is a wavelength at which the differential phase dφ(λ)/dλ becomes zero. In other words, the wavelength λ₀ is a particular wavelength at which the group refractive index n_{g}^{sample}(λ) of the test object and the group refractive index n_{g}^{medium}(λ) of the medium become equal to each other. Formula 4 expresses the relationship between the group refractive index of the test object and the group refractive index of the medium at the particular wavelength λ₀. The particular wavelength λ₀ can be determined by measuring a vertex (extreme value) of a region in which the vibration period of the interference signal in each of FIGS. 4A and 4B becomes long (S20):

n_{g}^{sample}(λ₀)=n_{g}^{medium}(λ₀) [Math. 4]

Then, the group refractive index n_{g}^{medium}(λ) of the medium 70 is calculated as the group refractive index n_{g}^{sample}(λ) of the test object at the particular wavelength (S30). In the embodiment, a medium temperature calculating unit including the temperature measuring unit that measures the temperature of the medium and the computer 100 that converts the measured temperature into the refractive index of the medium is provided. In this case, the phase refractive index n₀^{medium}(λ) of the medium 70 at a certain reference temperature T₀ and a temperature coefficient dn^{medium}(λ)/dT of the refractive index of the medium 70 are known. As in Formula 5, the group refractive index n_{g}^{medium}(λ) is calculated in connection with a measured temperature value T:

$$\begin{matrix}{n}^{medium} ( λ ) = {n}_{0}^{medium} ( λ ) + \frac{d {n}^{medium} ( λ )}{d T} ( T - {T}_{0} ) & [ Math . 5 ] \\ {n}_{g}^{medium} ( λ ) = {n}^{medium} ( λ ) - λ \frac{d {n}^{medium} ( λ )}{d λ} & \end{matrix}$$

In the method for calculating the group refractive index using Formula 4, since the group refractive index of the medium is provided, a thickness L of the test object does not exist. Therefore, even if the shape of the test object is unknown, it is possible to calculate the group refractive index of the test object.

In the embodiment, the group refractive index n_{g}^{sample}(λ₀) of the test object at the particular wavelength λ₀ is calculated. A method for calculating a group refractive index of the test object at a multiple wavelength, that is, a group refractive index dispersion curve n_{g}^{medium}(λ) is as follows.

When the refractive index of the medium changes, the particular wavelength λ₀ also changes. The refractive index of the medium changes when, for example, the temperature of the medium changes or a medium having a different refractive index is added. FIGS. 4A and 4B are graphs showing a change in the particular wavelength λ₀ when the temperature of the medium changes. By combining a change in the temperature of the medium or an addition of a different medium with the flowchart of FIG. 2, the group refractive index dispersion curve n_{g}^{sample}(λ) of the test object is obtained. Note that, in the method for measuring a group refractive index dispersion curve using a temperature change, the group refractive index of the test object at each temperature is calculated. For example, the group refractive index dispersion curve n_{g}^{sample}(λ) of the test object at the reference temperature T₀ is calculated by correcting the refractive index difference corresponding to the difference between the reference temperature and each temperature.

In the embodiment, the group refractive index of the test object is obtained. Since the phase refractive index Nₚ(λ) and the group refractive index N_{g}(λ) have a relationship such as that indicated by Formula 6, it is possible to calculate the phase refractive index of the test object using the group refractive index of the test object:

$$\begin{matrix}{N}_{g} ( λ ) = {N}_{p} ( λ ) - λ \frac{d {N}_{p} ( λ )}{d λ} & [ Math . 6 ] \\ {N}_{p} ( λ ) = C λ - λ \int \frac{{N}_{g} ( λ )}{{λ}^{2}} d λ & \end{matrix}$$

where C represents an integration constant.

Formula 6 indicates a general way of calculation from the phase refractive index Nₚ(λ) to the group refractive index N_{g}(λ). However, when calculating from the group refractive index N_{g}(λ) to the phase refractive index Nₚ(λ), the integration constant C is arbitrary.

Accordingly, when calculating from the group refractive index n_{g}^{sample}(λ) of the test object to the phase refractive index n^{sample}(λ) of the test object, it is necessary to assume the integration constant C. For example, if the integration constant C^{sample} of the test object is equal to an integration constant C^{glass} of a base material of the test object, it is possible to calculate the integration constant C^{glass} of the base material using the phase refractive index of the base material provided by a supplier of a glass material. Using the integration constant C^{glass} and Formula 6, it is possible to calculate the phase refractive index n^{sample}(λ) from the group refractive index n_{g}^{sample}(λ) of the test object.

Instead of calculating the integration constant C, it is possible to apply a method using the difference or ratio between the phase refractive index and the group refractive index. A method for calculating the phase refractive index using the difference and a method for calculating the phase refractive index using the ratio are represented by Formula 7:

$$\begin{matrix}{n}^{sample} ( λ ) = {N}_{p} ( λ ) - {N}_{g} ( λ ) + {n}_{g}^{sample} ( λ ) & [ Math . 7 ] \\ {n}^{sample} ( λ ) = {n}_{g}^{sample} ( λ ) + \frac{{N}_{p} ( λ ) - {N}_{g} ( λ )}{{N}_{g} ( λ ) - 1} \times ( {N}_{g}^{sample} ( λ ) - 1 ) & \end{matrix}$$

where the phase refractive index of the base material is Nₚ(λ) and the group refractive index of the base material is N_{g}(λ).

The particular wavelength Δ₀ in the embodiment is determined using an interference signal that vibrates. However, instead, a method for determining the particular wavelength may be one in which the phase difference between the reference light and the test light are calculated using a phase shift method and an extreme value of the phase difference is determined.

In the embodiment, the group refractive index of the test object is calculated by determining the particular wavelength λ₀ and substituting the group refractive index of the medium for the group refractive index of the test object at the particular wavelength λ₀. However, instead, it is possible to use a method for calculating the group refractive index of the test object as follows.

Using the phase shift method in which the mirror 51 is driven, the phase difference φ(λ) between the reference light and the test light (Formula 2) is calculated. By substituting the tilting dφ(λ)/dλ of the phase difference φ(λ) regarding the wavelength (Formula 3) into Formula 8, which is a deformation of Formula 3, the group refractive index n_{g}^{sample}(λ) of the test object is obtained:

$${n}_{g}^{sample} ( λ ) = {n}_{g}^{medium} ( λ ) - \frac{{λ}^{2}}{2 π L} \frac{d φ ( λ )}{d λ} \qquad [ Math . 8 ]$$

The group refractive index of the test object obtained by Formula 8 is a group refractive index within a measurement wavelength range (group refractive index dispersion curve) instead of a group refractive index at the particular wavelength λ₀. However, since the thickness L of the test object is unknown, it is necessary to assume the thickness L. For example, the assumed thickness value may be, for example, a separately measured thickness with another method or a design thickness of the test object.

When the assumed thickness value deviates from a true value L by a deviation ΔL (thickness deviation), the group refractive index n_{g}^{sample}(λ) has a refractive index deviation Δn_{g} due to the thickness deviation ΔL. When the thickness deviation ΔL is sufficiently smaller than the thickness L, a refractive index deviation Δn_{g}(λ) based on the thickness deviation ΔL is expressed by Formula 9:

$$λ {n}_{g} ( λ ) \approx \frac{{λ}^{2}}{2 π {L}^{2}} \frac{d φ ( λ )}{d λ} Δ L \qquad [ Math . 9 ]$$

Formula 9 shows that, at the particular wavelength λ₀ where dφ(λ)/dλ becomes zero, the refractive index deviation Δn_{g}(λ) becomes zero. Therefore, when the group refractive index is one at a wavelength near the particular wavelength λ₀ (wavelength corresponding to an extreme value of the phase difference between the reference light and the test light), the influence of the thickness deviation ΔL is reduced, and a highly precise value is obtained.

The wavelength range near the particular wavelength λ₀ that allows a highly precise measurement of the group refractive index, is, for example, estimated as follows. It is assumed that a phase refractive index dispersion formula of the test object 80 and the medium 70 is represented by Formula 10:

$$n = \sqrt{1 + \frac{A {λ}^{2}}{{λ}^{2} - B}} \qquad [ Math . 10 ]$$

For example, when coefficients of the test object are A=2.03 and B=0.025 and coefficients of the medium are A=1.8 and B=0.04, the particular wavelength λ₀ is 633 nm. When the thickness of the test object is L=1 mm, the thickness deviation is ΔL=5 μm, and a desired group refractive index measurement precision is Δn_{q}(λ)=0.0001, using Formulas 3 and 9, the range 570 to 730 nm becomes a wavelength band that allows highly precise measurement.

In the embodiment, interference light having a wide spectrum is spectrally dispersed at the detector 90. However, instead, it is possible to use a wavelength sweeping method. In the wavelength sweeping method, for example, a monochromator is arranged just behind the light source, quasi-monochromatic light is caused to exit therefrom, and an interference signal having a wavelength of the light is measured using the detector, such as a photodiode. Then, measurement at each wavelength is performed while performing wavelength scanning.

It is possible to combine the wavelength sweeping method with heterodyne interferometry. Heterodyne interferometry is not a mechanical phase shift method of the mirror 51 according to the embodiment, but a temporal phase shift method that causes a frequency difference to occur between reference light and test light at, for example, an acousto-optical element.

In the embodiment, a supercontinuum light source is used as the light source 10 having a wide wavelength band. However, instead, for example, a super luminescent diode (SLD), a halogen lamp, or a short pulse laser may also be used. When wavelength scanning is performed, a wavelength sweeping light source may be used instead of a combination of a wide band light source and a monochromator.

A refractive index distribution of the medium 70 occurs due to a temperature distribution of the medium 70. Therefore, a deviation occurs in the refractive index of the test object that is calculated. Consequently, it is desirable to perform temperature control using the temperature regulating mechanism (temperature regulating unit) so that a temperature distribution of the medium 70 does not occur. The deviation caused by the refractive index distribution of the medium 70 can be corrected if the amount of refractive index distribution is known. Therefore, it is desirable that a wavefront measuring device (wavefront measuring unit) for measuring the refractive index distribution of the medium 70 be provided.

In the embodiment, the mirror 51 is adjusted so that the optical path length of the test light and the optical path length of the reference light become equal to each other (Δ₀=0). However, instead, all that needs to be known is how much the current position has shifted from Δ₀=0. That is, all that is needed is for the current Δ₀ value to be specified. In this case, the phase difference φ(λ) between the reference light and the test light in Formula 2 is replaced by a phase difference Φ(λ) in Formula 11:

$$Φ ( λ ) ≡ φ + \frac{2 π}{λ} {Δ}_{0} = \frac{2 π}{λ} ( {n}^{sample} ( λ ) - {n}^{medium} ( λ ) ) L \qquad [ Math . 11 ]$$

In the embodiment, a Mach-Zehnder interferometer is used. However, instead, a Michelson interferometer may be used. Although, in the embodiment, the refractive index and the phase difference are calculated as a function of wavelength, they may be calculated as a function of frequency instead.

### Second Embodiment

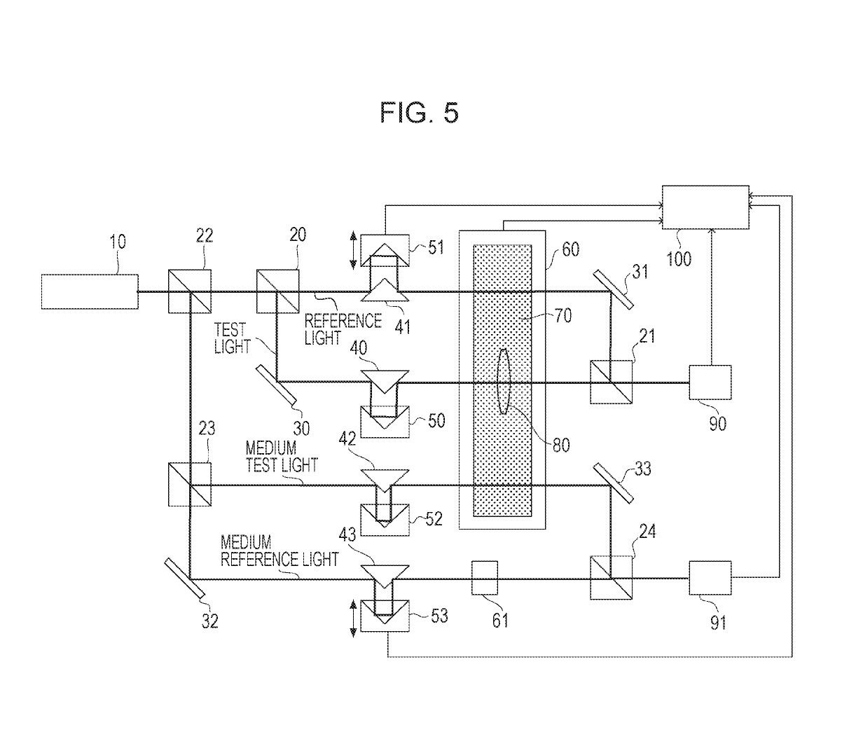

FIG. 5 is a block diagram of a refractive index measuring device according to a second embodiment of the present invention. An interferometer that measures the refractive index of a medium 70 is added to the refractive index measuring device according to the first embodiment. A test object is a lens having a positive refractive power. The other structural components are the same as those of the first embodiment. Corresponding structural components are given the same reference numerals and are described.

Light that has exited from a light source 10 is split into transmitted light and reflected light by a beam splitter 22. The transmitted light propagates towards an interference optical system that is provided for measuring the refractive index of a test object 80. The reflected light is guided towards an interference optical system that is provided for measuring the refractive index of the medium 70. The reflected light is further split into transmitted light (medium reference light) and reflected light (medium test light) by a beam splitter 23.

The medium test light reflected by the beam splitter 23 is reflected by mirrors 42 and 52, is, then, transmitted through a side surface of a container 60 and the medium 70, reflected by a mirror 33, and reaches a beam splitter 24. The medium reference light transmitted through the beam splitter 23 is reflected by mirrors 32, 43, and 53, is, then, transmitted through a compensator 61, and reaches the beam splitter 24. The medium reference light and the medium test light that have reached the beam splitter 24 interfere with each other, so that interference light is formed. The interference light is detected by a detector 91 including, for example, a spectrometer. A signal detected by the detector 91 is sent to a computer 100.

The compensator 61 has the role of correcting the influence of refractive index dispersion caused by a side surface of the container 60. The compensator 61 is formed of the same material as and has the same thickness (=thickness of a side surface of container 60×2) as the side surfaces of the container 60. When the interior of the container 60 is empty, the compensator 61 has the effect of causing the difference between an optical path length of the medium reference light and that of the medium test light at each wavelength to be equal to each other.

The mirror 53 is provided with a driving mechanism that is similar to that for the mirror 51, and is driven in the directions of a double-headed arrow in FIG. 5. The driving of the mirror 53 is controlled by the computer 100. The container 60 includes a temperature regulating mechanism, so that, for example, control of a change in the temperature of the medium and the temperature distribution of the medium can be performed. The temperature of the medium is also controlled by the computer 100.

A procedure for calculating a group refractive index of the test object 80 according to the embodiment is as follows.

First, a medium having a group refractive index that is equal to a group refractive index of a test object at a particular wavelength is arranged in an optical path of reference light and an optical path of test light (S10). Next, the particular wavelength is determined from the wavelength dependence of a phase difference between the reference light and the test light (S20). In the embodiment, a phase difference φ(λ) in Formula 2 is calculated by a phase shift method as follows.

An interference signal is obtained while driving the mirror 51 by tiny amounts. An interference intensity Iₖ(λ) when a phase shift amount (=driving amount×2π/λ) of the mirror 51 is δₖ (k=0, 1, . . . , M−1) is expressed by Formula 12:

Iₖ(λ)=I₀[1+γ cos(φ(λ)−δₖ)]=a₀+a₁ cos δₖ+a₂ sin δₖ(a₀=I₀, a₁=I₀γ cos φ(λ), a₂=I₀γ sin φ(λ)) [Math. 12]

The phase difference φ(λ) is calculated with Formula 13 using the phase shift amount δₖ and the interference intensity Iₖ(λ). In order to calculate the phase difference φ(λ) with high precision, it is desirable that the phase shift amount δₖ be as small as possible and the number M of driving steps be as large as possible. The calculated phase difference φ(λ) is wrapped modulo 2π. Therefore, it is necessary to perform unwrapping by connecting phase jumps using 2π. The obtained phase difference φ(λ) is any integral multiple of 2π (unknown offset term):

$$\begin{matrix}[ \begin{matrix}{a}_{0} \\ {a}_{1} \\ {a}_{2}\end{matrix} ] = {[ \begin{matrix}M & {\sum }_{k = 0}^{M - 1} cos {δ}_{k} & {\sum }_{k = 0}^{M - 1} sin {δ}_{k} \\ {\sum }_{k = 0}^{M - 1} cos {δ}_{k} & {\sum }_{k = 0}^{M - 1} {cos}^{2} {δ}_{k} & {\sum }_{k = 0}^{M - 1} cos {δ}_{k} sin {δ}_{k} \\ {\sum }_{k = 0}^{M - 1} sin {δ}_{k} & {\sum }_{k = 0}^{M - 1} cos {δ}_{k} sin {δ}_{k} & {\sum }_{k = 0}^{M - 1} {sin}^{2} {δ}_{k}\end{matrix} ]}^{- 1} [ \begin{matrix}{\sum }_{k = 0}^{M - 1} {I}_{k} \\ {\sum }_{k = 0}^{M - 1} {I}_{k} cos {δ}_{k} \\ {\sum }_{k = 0}^{M - 1} {I}_{k} sin {δ}_{k}\end{matrix} ] & [ Math . 13 ] \\ φ ( λ ) = {tan}^{- 1} \frac{{a}_{2}}{{a}_{1}} & \end{matrix}$$

From a wavelength corresponding to an extreme value of the phase difference φ(λ) calculated using Formula 13, a particular wavelength λ₀ is determined (S20). A wavelength at which a differential dφ(λ)/dλ of the phase difference φ(λ) becomes zero corresponds to the particular wavelength λ₀.

Since the phase difference φ(λ) is discrete data, the differential dφ(λ)/dλ of the phase difference is such that a rate of change of the phase difference φ(λ) between pieces of wavelength data is actually calculated. In general, an operation of calculating a differential amount of data amplifies the influence of noise. In order to reduce the influence of noise, all that needs to be done is to calculate a differential amount after smoothing original data. Alternatively, all that needs to be done is to smooth the differential data, itself.

Next, a group refractive index n_{g}^{medium}(λ) of the medium is calculated as a group refractive index n_{g}^{sample}(λ) of the test object (S30). A phase difference φ^{medium}(λ) between the medium reference light and the medium test light and a differential dφ^{medium}(λ)/dλ of the phase difference are expressed by Formula 14:

$$\begin{matrix}{φ}^{medium} ( λ ) = \frac{2 π}{λ} [ ( {n}^{medium} ( λ ) - 1 ) {L}^{tank} - Δ ] & [ Math . 14 ] \\ \frac{d {φ}^{medium} ( λ )}{d λ} = - \frac{2 π}{{λ}^{2}} [ ( {n}_{g}^{medium} ( λ ) - 1 ) {L}^{tank} - Δ ] & \end{matrix}$$

A represents the difference between the optical path length of the medium reference light and the optical path length of the medium test light, and L^{tank} represents the distance between the side surfaces of the container 60 (the optical path length of the medium test light in the medium 70). These quantities are known. λ represents the wavelength in air, so that the refractive index of air is included in the wavelength. Here, it is assumed that the phase refractive index of air is equal to the group refractive index of air. As in the method for calculating the phase difference φ(λ), the phase difference φ^{medium}(λ) between the medium reference light and the medium test light is measured using a phase shift method in which the mirror 53 is driven. When Formula 14 is deformed, the group refractive index n_{g}^{medium}(λ) of the medium is calculated (S30).

### Third Embodiment

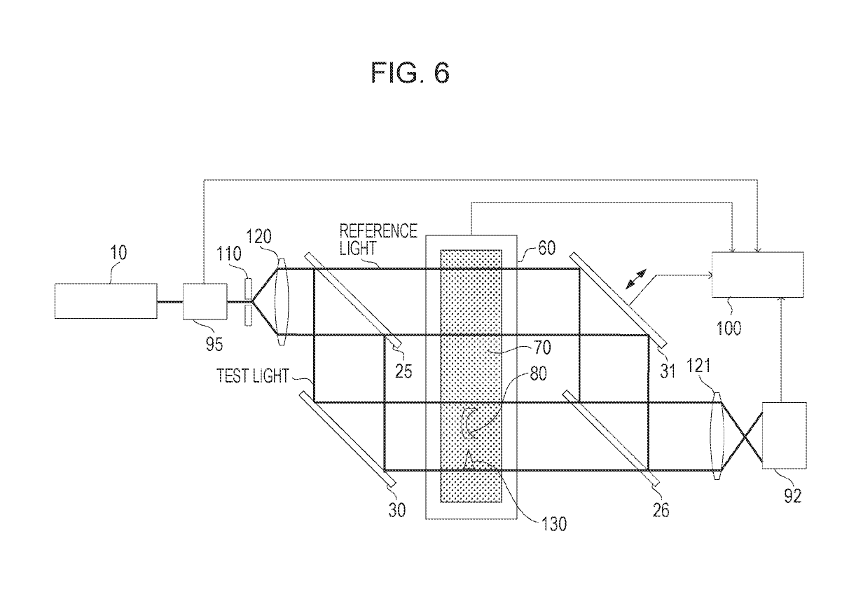

FIG. 6 is a block diagram of a refractive index measuring device according to a third embodiment of the present invention. A wavefront is measured using a two-dimensional sensor. In order to measure the refractive index of a medium, a glass prism (reference test object) whose refractive index and shape are known is arranged on a test light beam. Structural components corresponding to those according to the first and second embodiments are given the same reference numerals and are described.

Light that has exited from a light source 10 is spectrally dispersed by a monochromator 95, becomes quasi-monochromatic light, and is incident upon a pinhole 110. The wavelength of the quasi-monochromatic light that is incident upon the pinhole 110 is controlled by a computer 100. Light that has become divergent light as a result of passing through the pinhole 110 is collimated into parallel light by a collimator lens 120. The collimated light is split into transmitted light (reference light) and reflected light (test light) by a beam splitter 25.

The reference light that has been transmitted through the beam splitter 25 is transmitted through a medium 70 in a container 60, is, then, reflected by a mirror 31, and reaches a beam splitter 26. The mirror 31 is provided with a driving mechanism for a driving operation in the directions of a double-headed arrow in FIG. 6, and is controlled by the computer 100.

The test light reflected by the beam splitter 25 is reflected by a mirror 30, and is incident upon the container 60 including the medium 70, a test object 80, and a glass prism 130. Part of the test light is transmitted through the medium 70 and the test object 80. Part of the test light is transmitted through the medium 70 and the glass prism 130. The remaining part of the test light is transmitted only through the medium 70. The parts of the test light transmitted through the container 60 interfere with the reference light at the beam splitter 26, so that interference light is formed. The interference light is detected by a detector 92 (such as a charge-coupled device (CCD) or a complementary metal-oxide semiconductor (CMOS) sensor) via an imaging lens 121. An interference signal detected by the detector 92 is sent to the computer 100.

The detector 92 is arranged at a position that is conjugate with the positions of the test object 80 and the glass prism 130. When the phase refractive indices of the test object 80 and the medium 70 differ from each other, the light transmitted through the test object 80 becomes divergent light or convergent light. When the divergent light (convergent light) crosses light transmitted through something other than the test object 80, all that needs to be done is to cut off stray light using, for example, an aperture arranged behind (at a detector-92 side) of the test object 80.

The phase refractive index of the medium 70 is calculated by measuring the wavefront transmitted through the glass prism 130. It is desirable that the glass prism 130 have a phase refractive index that is substantially equal to the phase refractive index of the medium 70 so that interference fringes resulting from interference between the light transmitted through the glass prism 130 and the reference light are not too dense. An optical path length of the test light and an optical path length of the reference light are adjusted so as to be equal to each other when the test object 80 and the glass prism 130 are not arranged in the test light path.

A procedure for calculating the group refractive index of the test object 80 according to the embodiment is as follows.

First, a medium having a group refractive index that is equal to the group refractive index of a test object at a particular wavelength is arranged in an optical path of the reference light and an optical path of the test light (S10). Next, by performing a phase shift method using the driving mechanism of the mirror 31 and wavelength scanning using the monochromator 95, a phase difference φ(λ) between the test light and the reference light and a refractive index n^{medium}(λ) of the medium 70 are measured. From a wavelength dependence (φ(λ) or dφ(λ)/dλ) of the phase difference, a particular wavelength is determined (S20). From the refractive index n^{medium}(λ) of the medium 70, using Formula 5, a group refractive index n_{g}^{medium}(λ) of the medium 70 is calculated as a group refractive index n_{g}^{sample}(λ) of the test object.

### Fourth Embodiment

The results measured using the devices illustrated in the first to third embodiments may also be fed back to a method for producing an optical element, such as a lens.

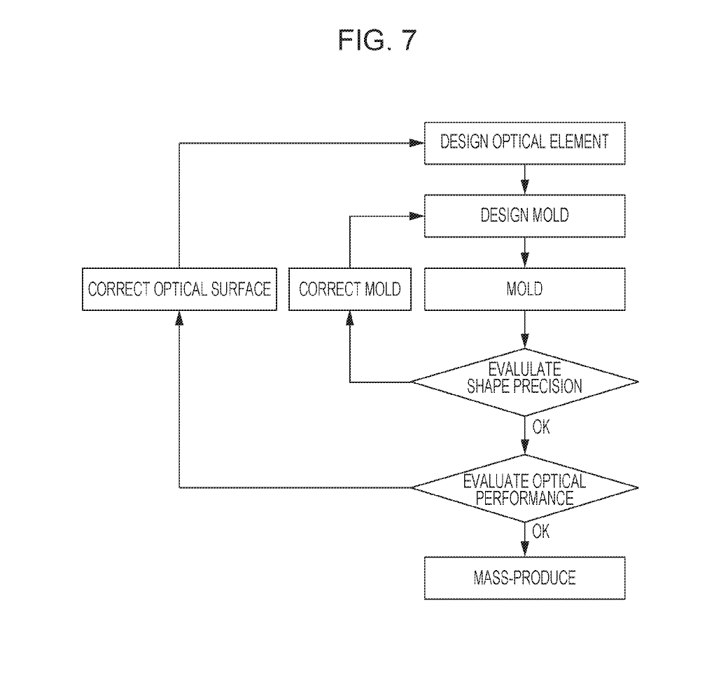

FIG. 7 illustrates exemplary production steps of a method for producing an optical element using a mold.

An optical element is produced by performing the step of designing the optical element, the step of designing the mold, and the step of molding the optical element using the mold. The precision of the shape of the molded optical element is evaluated. If the shape thereof lacks precision, the mold is corrected, and molding is performed again. If the precision of the shape thereof is good, the optical performance of the optical element is evaluated. In the step of evaluating the optical performance, it is possible to precisely mass-produce optical elements that are molded by utilizing the method for measuring a refractive index according to the present invention.

When the optical performance is low, the optical element whose optical surface has been corrected is redesigned.

The embodiments described above are merely typical embodiments. When carrying out these embodiments of the invention, various modifications and changes can be made with respect to these embodiments.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-136168, filed Jun. 28, 2013, which is hereby incorporated by reference herein in its entirety.

1. A method for measuring a refractive index of a test object by splitting light from a light source into test light and reference light, introducing the test light into the test object, and measuring interference light resulting from interference between the reference light and the test light transmitted through the test object, the method comprising steps of:
measuring, by arranging the test object in a medium whose group refractive index is equal to a group refractive index of the test object at a particular wavelength, interference light resulting from interference between test light transmitted through the test object and the medium and reference light transmitted through the medium;
determining the particular wavelength based on a wavelength dependence of a phase difference between the test light and the reference light; and
calculating the group refractive index of the medium corresponding to the particular wavelength as the group refractive index of the test object corresponding to the particular wavelength.

2. The method according to claim 1, wherein a wavelength corresponding to an extreme value of the phase difference between the test light and the reference light is determined as the particular wavelength.

3. The method according to claim 1, wherein the group refractive index of the medium is calculated by measuring a temperature of the medium and converting the measured temperature of the medium into a refractive index of the medium.

4. The method according to claim 1, wherein a reference test object whose refractive index and shape are known is arranged in the medium, light is introduced into the reference test object, a transmitted wavefront of the reference test object is measured, and the group refractive index of the medium is calculated based on the refractive index and shape of the reference test object and the transmitted wavefront of the reference test object.

5. The method according to claim 1, wherein the light from the light source is split into medium test light and medium reference light, the medium test light is introduced into the medium, interference light resulting from interference between the medium reference light and the medium test light transmitted through the medium is measured, and the group refractive index of the medium is calculated based on a phase difference between the medium reference light and the medium test light.

6. The method according to claim 1, further comprising a step of measuring a refractive index distribution of the medium.

7. The method according to claim 1, further comprising a step of controlling a temperature distribution of the medium.

8. A method for producing an optical element, the method comprising steps of:
molding the optical element, and
evaluating the molded optical element by measuring a refractive index of the optical element using the method according to claim 1.

9. A refractive index measuring device comprising:
a light source;
an interference optical system configured to split light from the light source into test light and reference light, introduce the test light into a test object, and cause the reference light and the test light transmitted through the test object to interfere with each other;
a detecting unit configured to detect interference light resulting from the interference between the test light and the reference light; and
a computing unit configured to compute a refractive index of the test object using an interference signal that is output from the detecting unit,
wherein the test object is arranged in a medium whose group refractive index is equal to a group refractive index of the test object at a particular wavelength,
wherein the interference optical system is an optical system that causes test light transmitted through the test object and the medium and reference light transmitted through the medium to interfere with each other, and
wherein the computing unit determines the particular wavelength based on a wavelength dependence of a phase difference between the test light and the reference light and calculates the group refractive index of the medium corresponding to the particular wavelength as the group refractive index of the test object corresponding to the particular wavelength.

10. The refractive index measuring device according to claim 9, wherein the computing unit determines a wavelength corresponding to an extreme value of the phase difference between the test light and the reference light as the particular wavelength.

11. The refractive index measuring device according to claim 9, further comprising a temperature measuring unit configured to measure a temperature of the medium,
wherein the computing unit calculates the group refractive index of the medium by converting the temperature of the medium measured by the temperature measuring unit into a refractive index of the medium.

12. The refractive index measuring device according to claim 9, further comprising:
a reference test object whose refractive index and shape are known; and
a wavefront measuring unit configured to measure a transmitted wavefront of light that is introduced into the reference test object arranged in the medium,
wherein the computing unit calculates the group refractive index of the medium based on the refractive index and shape of the reference test object and the transmitted wavefront of the reference test object.

13. The refractive index measuring device according to claim 9, further comprising:
an interference optical system configured to split the light from the light source into medium test light and medium reference light, introduce the medium test light into the medium, and cause the medium reference light and the medium test light transmitted through the medium to interfere with each other;
a detecting unit configured to detect interference light resulting from the interference between the medium reference light and the medium test light; and
a computing unit configured to calculate the group refractive index of the medium based on a phase difference between the medium reference light and the medium test light.

14. The refractive index measuring device according to claim 9, further comprising:
a wavefront measuring unit configured to measure a refractive index distribution of the medium.

15. The refractive index measuring device according to claim 9, further comprising:
a temperature controlling unit configured to control a temperature distribution of the medium.
